(19) United States
(12) Patent Application Publication
(10) Pub. No.: US 2024/0369312 A1
(43) Pub. Date: Nov. 7, 2024

(54) PARALLEL PLATE SUPPORT ELEMENTS

(71) Applicant: BLUE FRONTIER INC., Boca Raton, FL (US)

(72) Inventors: Daniel A. BETTS, Parkland, FL (US); Matthew TILGHMAN, Pennington, NJ (US); Matthew GRAHAM, West Palm Beach, FL (US)

(73) Assignee: BLUE FRONTIER INC., Boca Raton, FL (US)

(21) Appl. No.: 18/654,640

(22) Filed: May 3, 2024

Related U.S. Application Data
(60) Provisional application No. 63/500,205, filed on May 4, 2023.
(60) Provisional application No. 63/589,537, filed on Oct. 11, 2023.

(51) Int. Cl. F28F 3/02; F28F 3/06

(52) U.S. Cl. CPC F28F 3/027; F28F 3/06

(57) ABSTRACT

The disclosure relates to parallel plate and manifold assemblies for heat exchangers. In some examples, a plate assembly includes at least one plate. The plate includes a first side defining a side of a conditioning channel, where the first side is configured to receive desiccant. The plate also includes a second side that is opposite the first side. The second side defines a side of an exhaust channel. In addition, at least one of the first side and the second side include a plurality of support structures that are distributed in a predetermined pattern and are configured to maintain a predetermined width of the respective conditioning channel or exhaust channel.

### CROSS-REFERENCE TO RELATED APPLICATIONS

The application claims the benefit of priority to U.S. Provisional Patent Application No. 63/500,205, filed on May 4, 2023, and to U.S. Provisional Patent Application No. 63/589,537, filed on Oct. 11, 2023, the entire disclosures of which are expressly incorporated herein by reference to each of their entireties.

### TECHNICAL FIELD

The disclosure relates generally to heat exchangers and, more particularly, to parallel plate and manifold assemblies for heat exchangers.

### BACKGROUND

Heating ventilation and cooling (HVAC) systems generally cool ambient or room temperature air using a vapor compression refrigeration cycle. The HVAC systems may include a heat exchanger that operates to remove heat from a refrigerant. For example, the heat exchanger may include plates or coils through which the refrigerant flows. A fan may blow air across the plates or coils to cool the refrigerant flowing within. Less frequently, the heat exchangers may include a liquid desiccant to dehumidify the air during the cooling process.

### SUMMARY

In some examples, a plate assembly includes a plate. The plate includes a first side defining a side of a conditioning channel, where the first side is configured to receive desiccant. The plate also includes a second side that is opposite the first side. The second side defines a side of an exhaust channel. In addition, at least one of the first side and the second side include a plurality of support structures that are distributed in a predetermined pattern and are configured to maintain a predetermined width of the respective conditioning channel or exhaust channel.

In some examples, a plate assembly includes a first plate and a second plate. The first plate includes a first side that defines a first side of a conditioning channel, where the first side is configured to receive desiccant. The first plate also includes a second side that is opposite the first side. The second side of the first plate defines a side of an exhaust channel. In addition, the second plate includes a side opposite the first side of the first plate, and defines a second side of the conditioning channel. Further, at least one of the first side of the first plate and the side of the second plate includes a plurality of support structures that are distributed in a predetermined pattern and are configured to maintain a predetermined width of the conditioning channel.

In some examples, a plate assembly includes a first plate and a second plate. The first plate includes a first side that defines a first side of a conditioning channel, where the first side is configured to receive desiccant. The first plate also includes a second side that is opposite the first side. The second side of the first plate defines a side of an exhaust channel. In addition, the second plate includes a side opposite the second side of the first plate, and defines a second side of the exhaust channel. Further, at least one of the second side of the first plate and the side of the second plate includes a plurality of support structures that are distributed in a predetermined pattern and are configured to maintain a predetermined width of the exhaust channel.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1A illustrates a conditioning channel side of a plate assembly, in accordance with some embodiments;

FIG. 1B illustrates an exhaust channel side of a plate assembly, in accordance with some embodiments;

FIG. 1C illustrates each of a conditioning channel side and an exhaust channel side of a plate assembly, in accordance with some embodiments;

FIG. 1D illustrates the flow of fluids through channels of a heat exchanger, in accordance with some embodiments;

FIG. 2A illustrates a plate assembly, in accordance with some embodiments;

FIG. 2B illustrates a plate assembly, in accordance with some embodiments;

FIG. 2C illustrates a plate assembly, in accordance with some embodiments;

FIG. 3A illustrates a plate assembly, in accordance with some embodiments;

FIG. 3B illustrates a plate assembly, in accordance with some embodiments;

FIG. 4 illustrates a plate assembly, in accordance with some embodiments;

FIG. 5 illustrates a plate assembly, in accordance with some embodiments;

FIG. 6 illustrates a plate assembly, in accordance with some embodiments;

FIG. 7 illustrates a plate assembly, in accordance with some embodiments;

FIG. 8A illustrates airflow across a process channel side of a parallel plate assembly, in accordance with some embodiments;

FIG. 8B illustrates airflow across an exhaust channel side of a parallel plate assembly, in accordance with some embodiments;

FIG. 8C illustrates airflow across a process channel side of a parallel plate assembly, in accordance with some embodiments; and

FIG. 8D illustrates airflow across a process channel side of a parallel plate assembly, in accordance with some embodiments.

### DETAILED DESCRIPTION

The following discussion omits or only briefly describes conventional features of heat and mass exchangers that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “above” versus “below,” “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “operatively connected,” “operably connected,” and the like are such attachments, couplings, or connections that allow the pertinent structures to operate as intended by virtue of that relationship.

Embodiments of the present disclosure relate generally to heat exchangers and, more particularly, to parallel plate or air-to-air heat exchangers that facilitate the flow of multiple fluids to transfer heat from a fluid, such as water or liquid desiccant. The multiple flow of multiple fluids may include flows in different phases. For instance, one flow may be in gas form (e.g., air flow), and another flow may be in liquid form (e.g., water flow), with both flows participating in the heat transfer process. For instance, the two flows (e.g., external flows) may operate to remove heat from a third flow (e.g., an internal flow), such as water or liquid desiccant. In some examples the flows may mix, at least partially, before or after traversing through a parallel plate heat exchanger.

In some examples, embodiments may include a plate assembly that includes a first side that is opposite to a second side. The first side defines a side of a conditioning channel, while the second side defines a side of an exhaust channel. A first fluid flow, such as a supply air flow, may proceed through the conditioning channel in a first direction, and a second fluid flow, such as an exhaust air flow, may proceed through the exhaust channel in a second direction opposite the first direction. Further, at least one of the first side and the second side include a plurality of support structures distributed in a predetermined pattern (e.g., a number of support structures per unit area of the corresponding side). The plurality of support structures are configured to maintain a predetermined width of the respective conditioning channel or the exhaust channel. For instance, the plurality of support structures may be distributed on the first side of the plate, and may engage a second plate that defines another side of the conditioning channel. In this instance, the plurality of support structures maintain a predetermined width of the conditioning channel that extends between the first side of the plate and the second plate. As another example, the plurality of support structures may be distributed on the second side of the plate, and may engage a second plate that defines another side of the exhaust channel. In this instance, the plurality of support structures maintain a predetermined width of the exhaust channel that extends between the second side of the plate and the second plate.

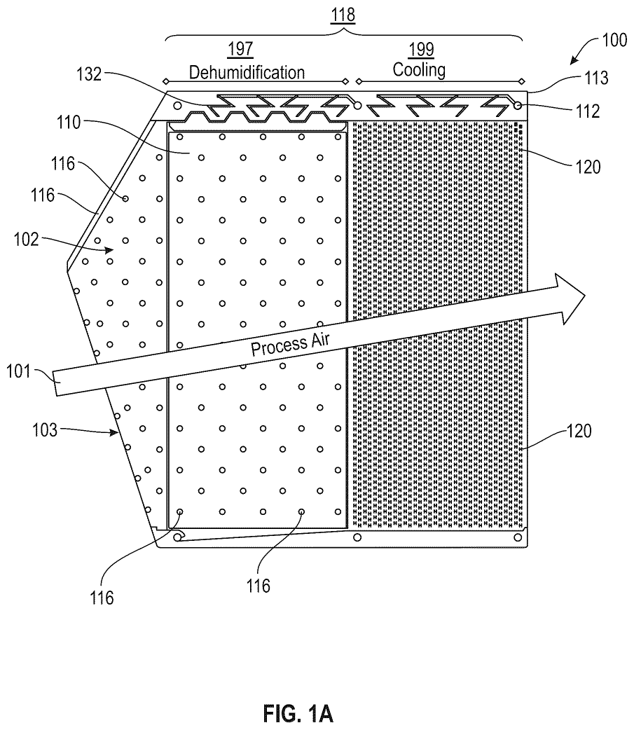

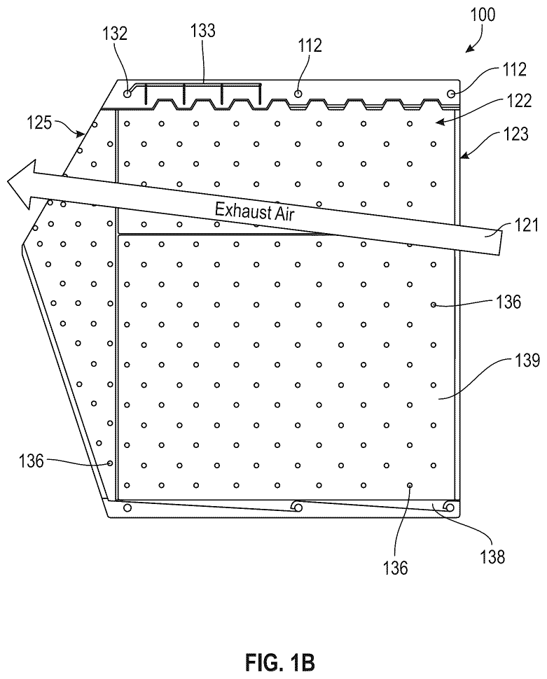

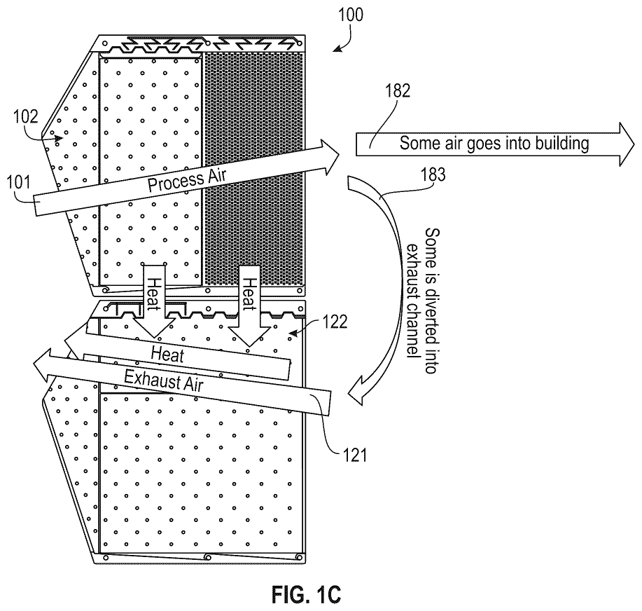

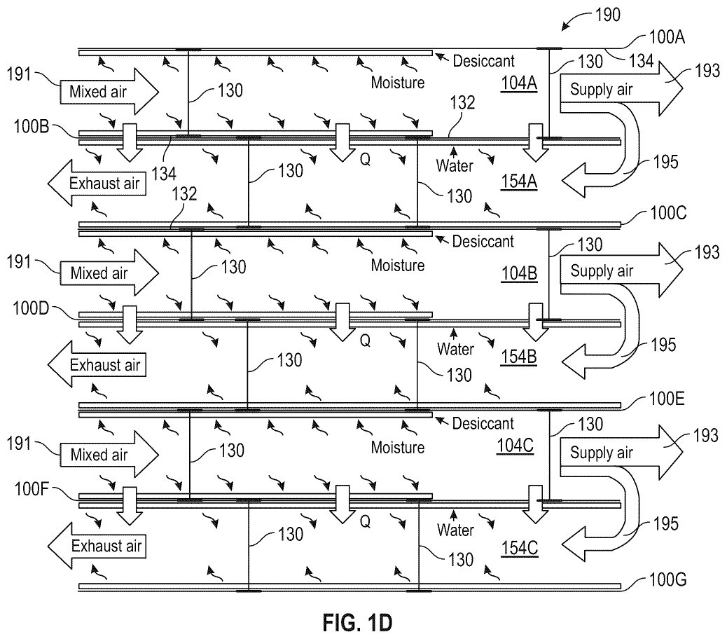

Referring to the drawings, FIGS. 1A and 1B illustrate an example plate assembly 100 that may be employed, for example, within a heat exchanger (e.g., a parallel plate, flat plate, or air-to-air heat exchanger), such as the heat exchanger 190 described below with respect to FIG. 1D. The heat exchanger may operate within, for example, an air conditioner, a regenerator, or any other suitable system requiring heat transfer. While FIG. 1A illustrates a conditioning channel 102 side of the plate assembly 100, FIG. 1B illustrates an exhaust channel 122 side of the plate assembly 100.

As illustrated in FIG. 1A, plate assembly 100 provides both a dehumidification stage 197 and an indirect evaporative cooling stage 199 of a side of a conditioning channel 102. A conditioning channel airflow 101 may enter the conditioning channel 102 through a conditioning channel opening 103. The conditioning channel airflow 101 may be dehumidified as it proceeds through the dehumidification stage 197, and may be cooled as it proceeds through the indirect evaporative cooling stage 199. For instance, the dehumidification stage 197 may include a wicking media 110 to which a liquid desiccant is provided through a distribution channel 132 (see also FIG. 1B) of a distribution header 113. As the conditioning channel airflow 101 proceeds through the conditioning channel 102, the liquid desiccant removes humidity from the conditioning channel airflow 101.

Further, the dehumidification stage 197 may include a plurality of spacers 116 positioned along the conditioning channel 102 side of the plate assembly 100. The plurality of spacers 116 may serve as support structures that maintain a predetermined width of the conditioning channel 102. For instance, the plurality of spacers 116 may be distributed along the conditioning channel 102 side of the plate assembly 100, and may engage a second plate that defines another side of the conditioning channel 102. In addition, the spacers 116 may be positioned in a predetermined pattern. For example, the spacers 116 may be uniformly distributed throughout at least a portion of a surface area 118 of the conditioning channel 102 side of the plate assembly 100. For instance, the spacers 116 may be uniformly distributed throughout the dehumidification stage 197 surface area portion of the conditioning channel 102 side of the plate assembly 100. In some embodiments, the dehumidification stage 197 surface area may be between 25% and 75% of the surface area 118 of the conditioning channel 102 side of the plate assembly 100.

The cooling stage 199 of the plate assembly 102 may include a plurality of heat transfer elements 120 that may absorb heat from the conditioning channel airflow 101 as it proceeds through the conditioning channel 102. In some examples, the plurality of heat transfer elements 120 are fin-shaped. The plurality of heat transfer elements 120 may further serve, in some examples, as support structures configured to maintain a predetermined width of the conditioning channel 102. For instance, the plurality of heat transfer elements 120 may be distributed on the side of the plate assembly 100, and may engage a second plate that defines another side of the conditioning channel 102. In some examples, as described herein, the cooling stage 199 of the plate assembly 102 may include spacers instead of or in addition to the plurality of heat transfer elements 120. The spacers may also serve as support structures configured to maintain a predetermined width of the conditioning channel 102. In some embodiments, the cooling stage 199 surface area may be between 15% and 75% of the surface area 118 of the conditioning channel 102 side of the plate assembly 100.

In addition, the plurality of heat transfer elements 120 may be positioned in a predetermined pattern. For example, the plurality of heat transfer elements 120 may be uniformly distributed throughout at least a portion of the cooling stage 199 surface area portion of the conditioning channel 102 side of the plate assembly 100. In some examples, the plurality of heat transfer elements 120 take up less than 15% of the cooling stage 199 surface area portion of the plate assembly 100. In other examples, the plurality of heat transfer elements 120 are distributed over at least 5% or at least 10% of the cooling stage 199 surface area portion of the plate assembly 100. In some examples, the plurality of heat transfer elements 120 are distributed over at least 5% and less than 10% of the cooling stage 199 surface area portion of the plate assembly 100. In some examples, the plurality of heat transfer elements 120 are distributed over at least 50% (e.g., 75%, 90%) of the cooling stage 199 surface area portion of the plate assembly 100.

In some instances, as described herein, at least some of the plurality of heat transfer elements 120 are formed by portions of the side of the plate assembly 100 (e.g., cutouts) that fold into a channel (e.g., the conditioning channel 102). For at least some of these instances, the plurality of heat transfer elements 120 take up less than 15% of the area of the side of the plate assembly 100. For at least some of these instances, the plurality of heat transfer elements 120 are distributed over at least 5% or at least 10% of the area of the side of the plate assembly 100. For at least some of these instances, the plurality of heat transfer elements 120 are distributed over at least 5% and less than 10% of the area of the side of the plate assembly 100.

FIG. 1B illustrates a side of an exhaust channel 122 provided by the plate assembly 100. In this example, an exhaust channel airflow 121 may enter the exhaust channel 122 through a first exhaust channel opening 123, and may proceed through the exhaust channel 122 until exiting the exhaust channel 122 through a second exhaust channel opening 125. Further, the exhaust channel 122 may include wicking media 139 to which a working fluid, such as water, is provided through one or more distribution channels 112 of a distribution header 133 (see also FIG. 1A). As the exhaust channel airflow 121 proceeds through the exhaust channel 122, water evaporates from the wicking media 139 thereby cooling plate assembly 100 and, indirectly, cooling the conditioning channel airflow 101 flowing through the conditioning channel 102.

Further, the exhaust channel 122 may include a plurality of spacers 136 positioned along the exhaust channel side of the plate assembly 100. As described herein, the plurality of spacers 136 may serve as support structures that maintain a predetermined width of the exhaust channel 122. For instance, the plurality of spacers 136 may be distributed on the exhaust channel 122 side of the plate assembly 100, and may engage a second plate that defines another side of the exhaust channel 122. In addition, the spacers 136 may be positioned in a predetermined pattern. For example, the spacers 136 may be uniformly distributed throughout at least a portion of a surface area 138 of the exhaust channel 122 side of the plate assembly 100.

FIG. 1C illustrates the conditioning channel airflow 101 (e.g., mixed air) proceeding across the conditioning channel 102 side of the plate assembly 100. As illustrated, while a portion of the conditioning channel airflow 101 exiting the conditioning channel 102 is provided as supply air 182 (e.g., supply air to a building), another portion 183 of the conditioning channel airflow 101 exiting the conditioning channel 102 is diverted to the exhaust channel 122 to form at least part of the exhaust channel airflow 121. While the conditioning channel 102 dehumidifies and cools the conditioning channel airflow 101 as it flows there through, the exhaust channel airflow 121 removes heat from the conditioning channel 102 as it flows there through. As such, plate assembly 100 may facilitate at least two fluid flows, with both flows participating in the heat transfer process.

FIG. 1D illustrates a top view of a heat exchanger 190 that includes a plurality of plate assemblies 100, including first plate 100A, a second plate 100B, a third plate 100C, a fourth plate 100D, a fifth plate 100E, a sixth plate 100F, and a seventh plate 100G. The plates 100A, 100B, 100C, 100D, 100E, 100F, and 100G define a plurality of conditioning channels 104 and a plurality of exhaust channels 154. For instance, the first plate 100A and the second plate 100B define a first conditioning channel 104A. Further, the second plate 100B and the third plate 100C define a first exhaust channel 154A. Similarly, the third plate 100C and the fourth plate 100D define a second conditioning channel 104B, and the fourth plate 100D and the fifth plate 100E define a second exhaust channel 154B. Additionally, the fifth plate 100E and the sixth plate 100F define a third conditioning channel 104C, and the sixth plate 100F and the seventh plate 100G define a third exhaust channel 154C.

In addition, one or more support structures 130 are positioned between adjacent plate assemblies 100 to maintain a predetermined distance of a corresponding channel (e.g., a conditioning channel 104 or an exhaust channel 154). Each support structure 130 may be coupled to a surface 132 of a respective first plate assembly 100 (e.g., plate 100C) and, additionally or alternatively, to a surface 134 of a respective second plate assembly 100 (e.g., plate 100B). The surface 132 of the respective first plate assembly 100 and the surface 134 of the respective second plate assembly 100 may form a corresponding channel, such as a conditioning channel 104 or exhaust channel 154. In some examples, the support structures 130 and the plates 100 may be manufactured from metal or another material that is thermally conductive.

Further, as illustrated, mixed air 191 enters the plurality of conditioning channels 104 and is dehumidified and cooled, resulting in a flow of supply air 193 exiting the plurality of conditioning channels 104. Wicking media, such as wicking media 110, may be positioned along the plurality of conditioning channels 104 and may include liquid desiccant that dehumidifies the mixed air 191. Moreover, a portion of the supply air 193 exiting the plurality of conditioning channels 104 enters the plurality of exhaust channels 154 as part of a flow of exhaust air 195 flowing through the plurality of exhaust channels 154. While flowing through the plurality of exhaust channels 154, the flow of exhaust air 195 absorbs heat from the water 196 accumulated within wicking media, such as wicking media 122, positioned along the plurality of exhaust channels 154.

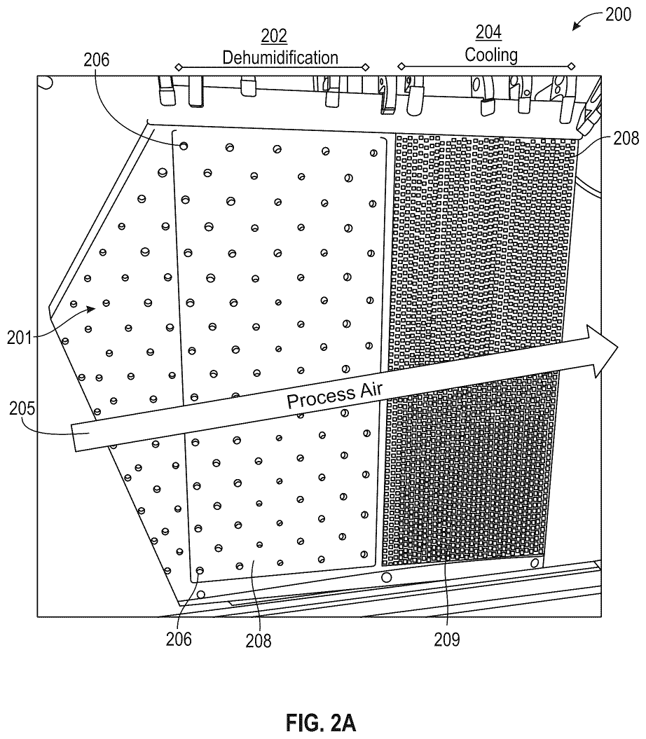

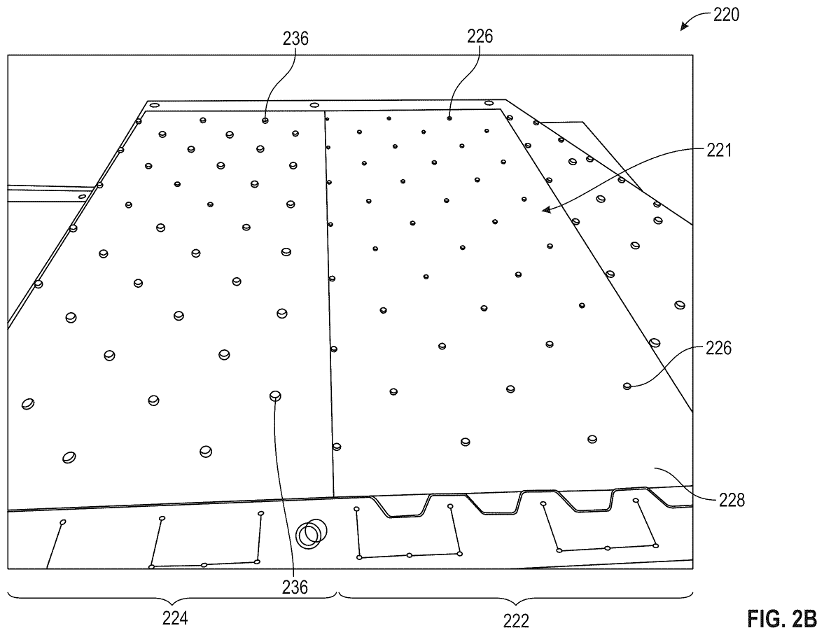

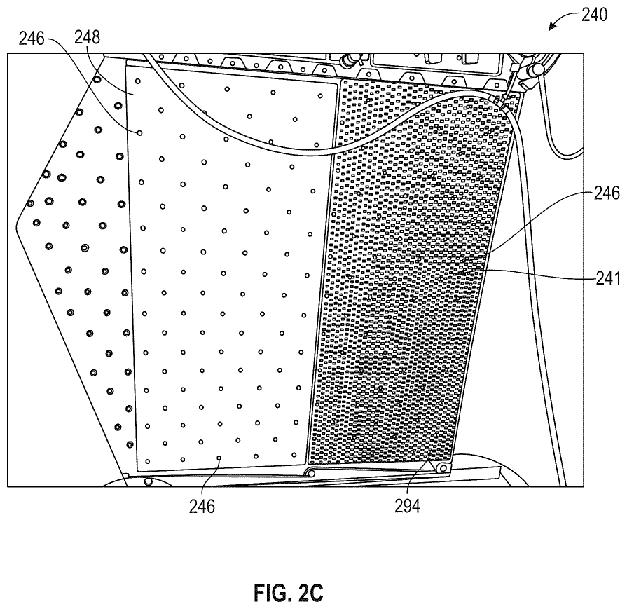

FIG. 2A illustrates a plate assembly 200 that can provide a side of a conditioning channel 201 that includes a dehumidification stage 202 and a cooling stage 204 for a conditioning channel airflow 205. The dehumidification stage 202 may include a plurality of embossed features 206 that, in some examples, secure a wicking media 208 to a surface of the plate assembly 200. The wicking media 208 may include a liquid desiccant that dehumidifies the conditioning channel airflow 205 as it proceeds through the dehumidification stage 202. The embossed features 206 may be stamped, molded, machined, 3D printed, or additively attached to the side of the plate assembly 200. Further, the embossed features 206 may be distributed throughout the dehumidification stage 202 in a predetermined pattern. As described herein, in some examples, one or more of the embossed features 206 may further serve as support structures configured to maintain a predetermined width of the conditioning channel 201. For instance, one or more of the embossed features 206 may engage one or more corresponding embossed features on a second plate that defines the other side of the conditioning channel 201.

Further, the cooling stage 204 may include a plurality of heat transfer elements 209 that may absorb heat from the conditioning channel airflow 205 as it proceeds through the conditioning channel 201. The plurality of heat transfer elements 209 may further serve, in some examples, as support structures configured to maintain a predetermined width of the conditioning channel 201. For instance, the plurality of heat transfer elements 209 may be distributed on the side of the plate assembly 200, and may engage a second plate that defines another side of the conditioning channel 201. Although illustrated with respect to the conditioning channel 201, in some examples, an exhaust channel, such as the exhaust channel side 152 of the plate assembly 100 illustrated in FIG. 1B, may include support structures, such as the embossed features 206 described herein.

FIG. 2B illustrates a plate assembly 220 that can provide a side of a conditioning channel 221 that includes a dehumidification stage 222 that can dehumidify a conditioning channel airflow and a cooling stage 224 that can cool the conditioning channel airflow. The dehumidification stage 222 may include a plurality of spacers 226 positioned over a wicking media 228 that is attached (e.g., glued) to a surface of the plate assembly 220. The wicking media 228 may include a liquid desiccant that dehumidifies the conditioning channel airflow as it proceeds through the dehumidification stage 222. The plurality of spacers 226 may be distributed throughout the dehumidification stage 222 in a predetermined pattern. The spacers 226 may serve as support structures configured to maintain a predetermined width of the conditioning channel 221. For instance, one or more of the spacers 226 may engage a side of a second plate that defines the other side of the conditioning channel 221.

Further, the cooling stage 224 may include a plurality of embossed features 236 that may be stamped, molded, machined, 3D printed, or additively attached to the side of the plate assembly 220. Further, the embossed features 236 may be distributed throughout the cooling stage 224 in a predetermined pattern. As described herein, in some examples, one or more of the embossed features 236 may further serve as support structures configured to maintain a predetermined width of the conditioning channel 221. For instance, one or more of the embossed features 236 may engage one or more corresponding embossed features on a second plate that defines the other side of the conditioning channel 221.

Although illustrated with respect to the conditioning channel 221, in some examples, an exhaust channel, such as the exhaust channel side 152 of the plate assembly 100 illustrated in FIG. 1B, may include support structures, such as the embossed features 236 and/or spacers 226 described herein. For instance, the plurality of support structures may maintain a predetermined width of a conditioning channel 221 that extends between a first side of the plate assembly 220 and a second plate. In addition, a plurality of support structures may be distributed on a second side of the plate assembly 220 that defines a first side of an exhaust channel, and may engage a third plate that defines another side of the exhaust channel. In this instance, the plurality of support structures may maintain a predetermined width of the exhaust channel that extends between the second side of the plate assembly 220 and the third plate.

FIG. 2C illustrates a plate assembly 240 that can provide a side of an exhaust channel 241. In this example, the exhaust channel 241 includes wicking media 248 that is attached (e.g., glued) to a surface of the plate assembly 240. In addition, the exhaust channel 241 includes a plurality of embossed features 246 that may be stamped, molded, machined, 3D printed, or additively attached to the side of the plate assembly 240. Further, the embossed features 246 may be distributed throughout the exhaust channel 241 in a predetermined pattern. As described herein, in some examples, one or more of the embossed features 246 may further serve as support structures (e.g., spacers) configured to maintain a predetermined width of the exhaust channel 241. For instance, one or more of the embossed features 246 may engage one or more corresponding embossed features on a second plate that defines the other side of the exhaust channel 241. In some instances, one or more of the embossed features 246 may engage a side of a second plate that defines the other side of the exhaust channel 241.

In some examples, the embossed features 246 may be distributed throughout the exhaust channel 241. For instance, the embossed features 246 may be distributed throughout the exhaust channel 241 in a predetermined pattern.

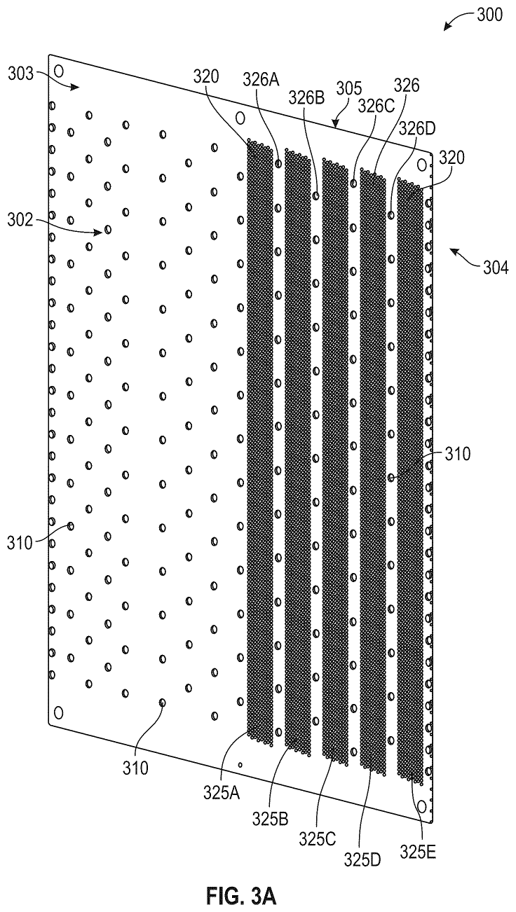

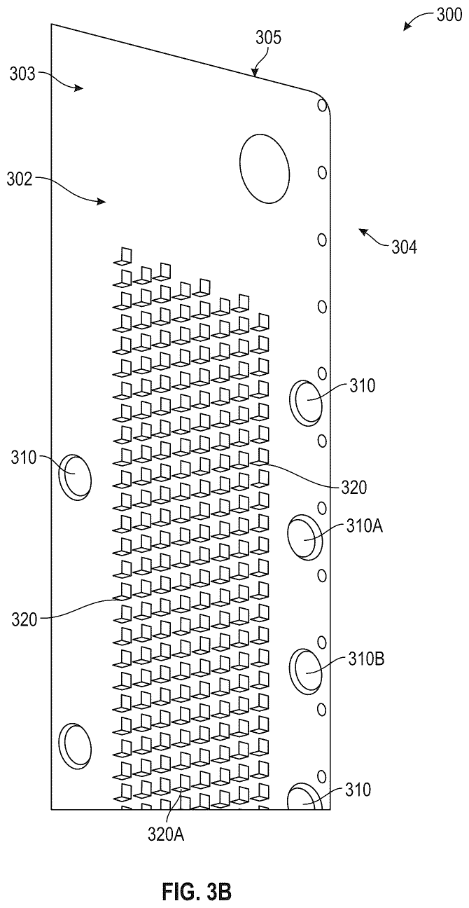

FIG. 3A illustrates a plate assembly 300 that includes a conditioning channel side 303 and an exhaust channel side 305. The conditioning channel side 303 may define one side of a conditioning channel 302, and the exhaust channel side 305 may define one side of an exhaust channel 304. For instance, a second plate assembly 300 may be placed adjacent the conditioning channel side 303 of the plate assembly 300 to define the other side of the conditioning channel 302. Likewise, a third plate assembly 300 may be placed adjacent the exhaust channel side 305 of the plate assembly 300 to define the other side of the exhaust channel 304.

Further, as illustrated, the conditioning channel side 303 of the plate assembly 300 includes a plurality of embossed features 310. The plurality of embossed features 310 may be distributed throughout the conditioning channel side 303 of the plate assembly 300 in a predetermined manner. As described herein, the plurality of embossed features 310 may be stamped, molded, machined, 3D printed, or additively attached to the conditioning channel side 303 of the plate assembly 300. In some instances, the plurality of embossed features 310 may serve as support structures that maintain a predetermined width of the conditioning channel. For instance, one or more of the embossed features 310 may engage one or more corresponding embossed features on a second plate that defines the other side of the conditioning channel.

The conditioning channel side 303 of the plate assembly 300 may also include a plurality of heat transfer elements 320 that absorb heat from an airflow as it proceeds through the conditioning channel 302. In some examples, the plurality of heat transfer elements 320 may be fin-shaped. As illustrated, the heat transfer elements may be cutouts into the plate assembly 300 that, in this example, are fin-shaped, and fold down into the conditioning channel 302. The plurality of heat transfer elements 320 may serve, in some examples, as support structures configured to maintain a predetermined width of the conditioning channel 302. For instance, the plurality of heat transfer elements 320 may engage a second plate that defines another side of the conditioning channel 302.

In this example, a first subset 325A of the heat transfer elements 320 is separated from a second subset 325B of the heat transfer elements by a first column 326A of the embossed features 310. Similarly, the second subset 325B of the heat transfer elements 320 is separated from a third subset 325C of the heat transfer elements 320 by a second column 326B of the embossed features 310. Moreover, the third subset 325C of the heat transfer elements 320 is separated from a fourth subset 325D of the heat transfer elements 320 by a third column 326C of the embossed features 310. In addition, the fourth subset 325D of the heat transfer elements 320 is separated from a fifth subset 325E of the heat transfer elements by a fourth column 326D of the embossed features 310.

FIG. 3B illustrates a magnified view of a portion of the plate assembly 300 of FIG. 3A. As illustrated, each of the plurality of embossed features 310 may protrude either into the conditioning channel 302 or the exhaust channel 304. For instance, embossed feature 310A protrudes out towards the conditioning channel 302. Embossed feature 310B, however, protrudes out towards the exhaust channel 304. As described herein, an embossed feature 310 may engage another embossed feature 310 that is part of a corresponding channel. For example, embossed feature 310A may engage an embossed feature from a second plate assembly 300 that protrudes into the conditioning channel 302. The embossed features 310 may serve as support elements. In some instances, the embossed features 310 do not facilitate heat transfer, while in some examples, the embossed features 310 do facilitate heat transfer (e.g., they act as heat transfer elements). Further, in this example, the heat transfer elements 320 include a fin, such as fin 320A, that protrudes into the conditioning channel 302. The fins of the heat transfer elements 320, such as fin 320A, may engage a second plate that defines another side of the conditioning channel 302.

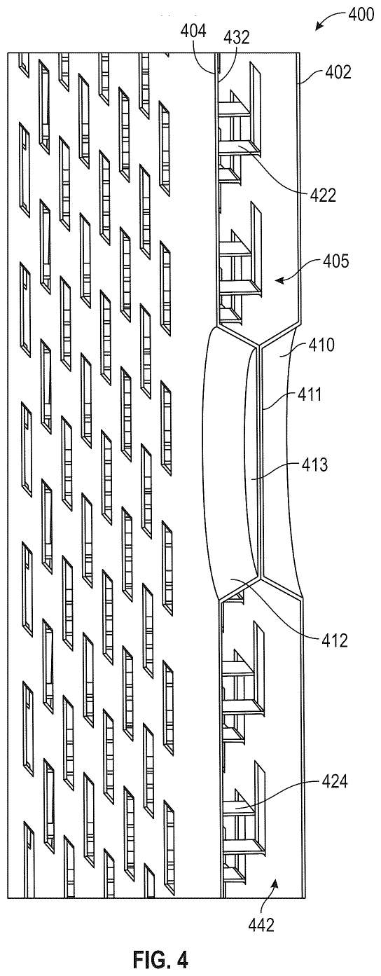

FIG. 4 illustrates a cutaway view of a plate assembly 400 that includes a first plate 402 and a second plate 404 that define a channel 405, such as a conditioning channel. As illustrated, the first plate 402 may include a first embossed feature 410 that extends into the channel 405 and engages a second embossed feature 412 of the second plate 404. More specifically, an outside surface 411 of the first embossed feature 410 engages an outside surface 413 of the second embossed feature 412.

In addition, the first plate 402 includes a plurality of first heat transfer elements 422, and the second plate 404 includes a plurality of second heat transfer elements 424. The plurality of first heat transfer elements 422 are designed as cutouts of portions of the first plate 402 that protrude (e.g., fold into) into the channel 405 and engage an inside surface 432 of the second plate 404. Similarly, the plurality of second heat transfer elements 424 are designed as cutouts of portions of the second plate 404 that protrude into the channel 405 and engage an inside surface 442 of the first plate 402.

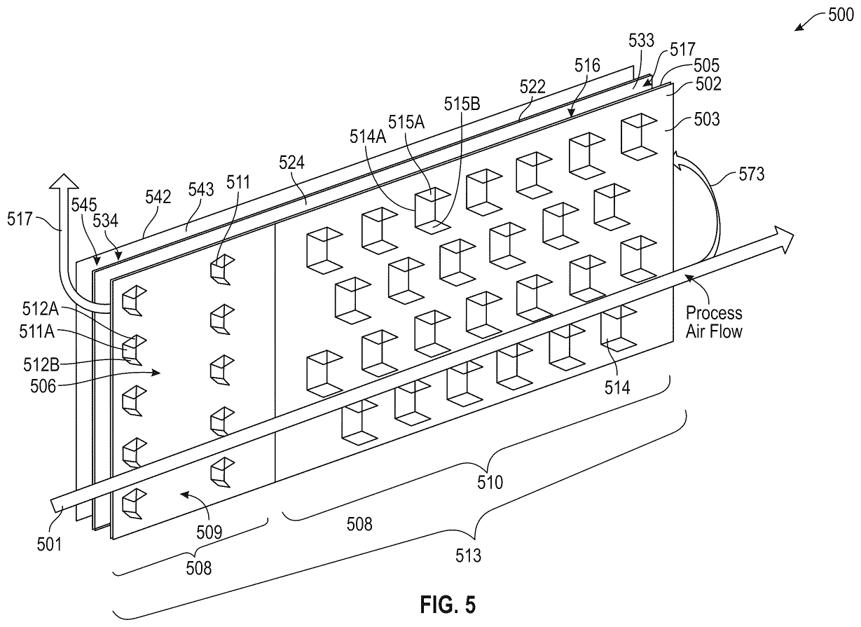

FIG. 5 illustrates a plate assembly 500 that includes a first plate 502, a second plate 522, and a third plate 542. A first side 503 of the first plate 502 may define a side of a conditioning channel 506 that includes a dehumidification stage 508 and an indirect evaporative cooling stage 510. A conditioning channel airflow 501 may enter the conditioning channel 506, and may be dehumidified as it proceeds through the dehumidification stage 508. For instance, the dehumidification stage 508 may include a wicking media 509 that includes liquid desiccant. As the conditioning channel airflow 501 proceeds through the conditioning channel 506, the liquid desiccant removes humidity from the conditioning channel airflow 501. In this example, the dehumidification stage 508 also includes a plurality of heat transfer elements 511. The plurality of heat transfer elements 511 may, in some examples, serve as mass transfer elements (e.g., turbulators) that cause turbulence of the conditioning channel airflow 501. Each of the heat transfer elements 511 include a pair of fins. The pair of fins may be portions of first plate 502 that fold into the conditioning channel 506. For example, heat transfer element 511A includes a first fin 512A and a second fin 512B. In some examples, each of the fins may be configured to engage a side of another plate that defines the conditioning channel 506. In some examples, one or more of the fins do not engage a side of another plate. Further, in this example, the dehumidification stage 508, including wicking media 509, may take up between 15% and 45% of a surface area 513 of the first side 503 of the plate assembly 500. For instance, the dehumidification stage 508, including wicking media 509, can take up 25% of the surface area 513 of the first side 503 of the plate assembly 500.

Further, the conditioning channel airflow 501 may be cooled as it proceeds through the indirect evaporative cooling stage 510. As illustrated, the indirect evaporative cooling stage 510 includes a plurality of heat transfer elements 514. Each of the heat transfer element 514 includes a pair of fins. For example, heat transfer element 514A includes a first fin 515A and a second fin 515B. Each of the fins are configured to engage a side of another plate that defines the conditioning channel 506. As described herein, the plurality of heat transfer elements 514 may be positioned according to a predetermined pattern. The plurality of heat transfer elements 514 may take up a portion of the evaporative cooling stage 510 surface area of the first side 503. For instance, in this example, the plurality of heat transfer elements 514 take up at least 15% of the evaporative cooling stage 510 surface area of the first side 503 of the first plate 502. In some examples, the plurality of heat transfer elements 514 take up between 5% and 10% of the evaporative cooling stage 510 surface area of the first side 503 of the first plate 502. In some examples, the plurality of heat transfer elements 514 take up to 50% of the evaporative cooling stage 510 surface area of the first side 503 of the first plate 502. In some examples, the plurality of heat transfer elements 514 take up at least 50% of the evaporative cooling stage 510 surface area of the first side 503 of the first plate 502. For instance, the plurality of heat transfer elements 514 may take up between 50% and 90% of the evaporative cooling stage 510 surface area of the first side 503 of the first plate 502.

A second side 505 of the first plate 502 along with a first side 533 of the second plate 522 may define an exhaust channel 516. For example, an exhaust channel airflow 517 may proceed through the exhaust channel 516. In some examples, the exhaust channel airflow 517 includes at least a portion 573 of the conditioning channel airflow 501 exiting the conditioning channel 506. The second side 505 of the first plate 502 may include a first wicking media 524 to which a working fluid, such as water, is provided. As the exhaust channel airflow 517 proceeds through the exhaust channel 516, water evaporates from the first wicking media 524 thereby cooling plate assembly 500 and, indirectly, cooling the conditioning channel airflow 501 flowing through the conditioning channel 506.

A second side 534 of the second plate 522 along with a first side 543 of the third plate 542 may define a second conditioning channel 545. As such, plate assembly 500 is configured such that conditioning channels and exhaust channels alternate. For instance, additional plates may be added to plate assembly 500 to configure additional and alternating conditioning channels and exhaust channels.

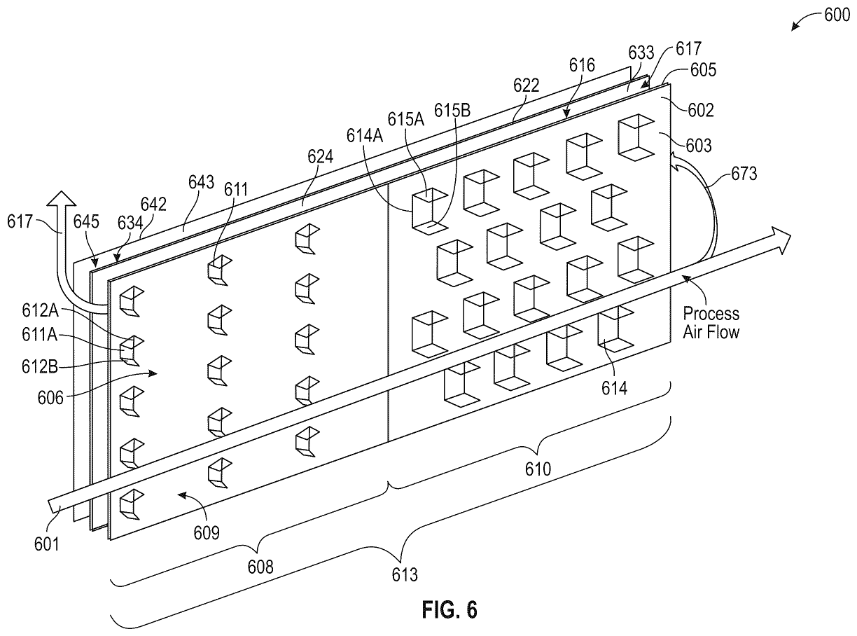

FIG. 6 illustrates a plate assembly 600 that includes a first plate 602, a second plate 622, and a third plate 642. A first side 603 of the first plate 502 may define a side of a conditioning channel 606 that includes a dehumidification stage 608 and an indirect evaporative cooling stage 610. A conditioning channel airflow 601 may enter the conditioning channel 606, and may be dehumidified as it proceeds through the dehumidification stage 608. For instance, the dehumidification stage 608 may include a wicking media 609 that includes liquid desiccant. As the conditioning channel airflow 601 proceeds through the conditioning channel 606, the liquid desiccant removes humidity from the conditioning channel airflow 601. In this example, the dehumidification stage 608, including wicking media 609, takes up between 20% and 45% of a surface area 613 of the first side 603 of the plate assembly 600. In some examples, the dehumidification stage 608, including wicking media 609, takes up between 15% and 75% of the surface area 613 of the first side 603 of the plate assembly 600. For instance, the dehumidification stage 608, including wicking media 609, can take up 50% of the surface area 613 of the first side 603 of the plate assembly 600.

Further, the conditioning channel airflow 601 may be cooled as it proceeds through the indirect evaporative cooling stage 610. As illustrated, the indirect evaporative cooling stage 610 includes a plurality of heat transfer elements 614. Each of the heat transfer element 614 includes a pair of fins. The pair of fins may be portions of first plate 602 that fold into the conditioning channel 606. For example, heat transfer element 611A, located within the dehumidification stage 608, includes a first fin 612A and a second fin 612B, and heat transfer element 614A, located within the indirect evaporative cooling stage 610, includes a first fin 615A and a second fin 615B. Each of the fins are configured to engage a side of another plate that defines the conditioning channel 606. As described herein, the plurality of heat transfer elements 614 may be positioned according to a predetermined pattern. For instance, in this example, the plurality of heat transfer elements 614 take up at least 15% of the evaporative cooling stage 610 surface area of the first side 603 of the first plate 602. In some examples, the plurality of heat transfer elements 614 take up between 5% and 10% of the evaporative cooling stage 610 surface area of the first side 603 of the first plate 602.

A second side 605 of the first plate 602 along with a first side 633 of the second plate 622 may define an exhaust channel 616. For example, an exhaust channel airflow 617 may proceed through the exhaust channel 616. In some examples, the exhaust channel airflow 617 includes at least a portion 673 of the conditioning channel airflow 601 exiting the conditioning channel 606. The second side 605 of the first plate 602 may include a first wicking media 624 to which a working fluid, such as water, is provided. As the exhaust channel airflow 617 proceeds through the exhaust channel 616, water evaporates from the first wicking media 624 thereby cooling plate assembly 600 and, indirectly, cooling the conditioning channel airflow 601 flowing through the conditioning channel 606.

A second side 634 of the second plate 622 along with a first side 643 of the third plate 642 may define a second conditioning channel 645. As such, plate assembly 600 is configured such that conditioning channels and exhaust channels alternate. For instance, additional plates may be added to plate assembly 600 to configure additional and alternating conditioning channels and exhaust channels.

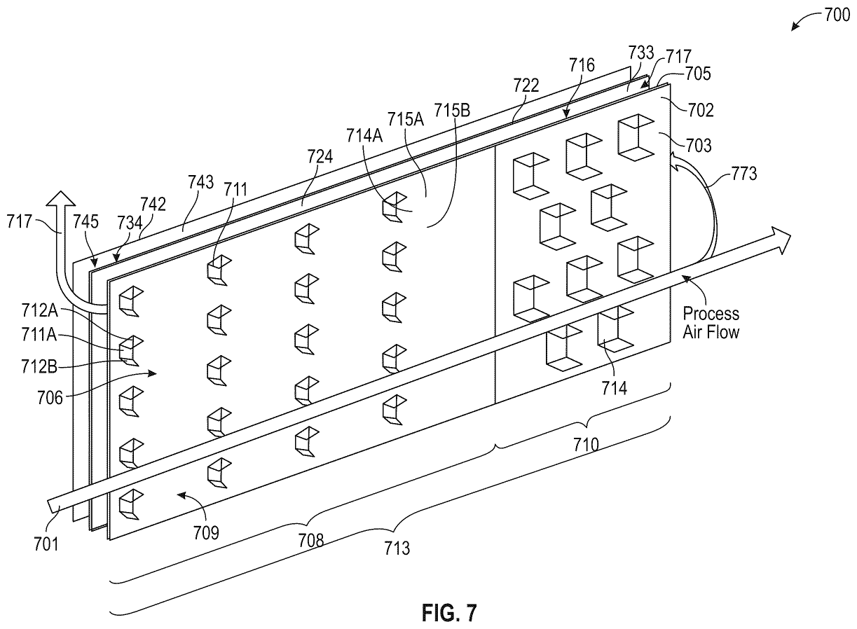

FIG. 7 illustrates a plate assembly 700 that includes a first plate 702, a second plate 722, and a third plate 742. A first side 703 of the first plate 702 may define a side of a conditioning channel 706 that includes a dehumidification stage 708 and an indirect evaporative cooling stage 710. A conditioning channel airflow 701 may enter the conditioning channel 706, and may be dehumidified as it proceeds through the dehumidification stage 708. For instance, the dehumidification stage 708 may include a wicking media 709 that includes liquid desiccant. As the conditioning channel airflow 701 proceeds through the conditioning channel 706, the liquid desiccant removes humidity from the conditioning channel airflow 701. In this example, the dehumidification stage 708, including wicking media 709, takes up between 45% and 75% of a surface area 713 of the first side 703 of the plate assembly 700. In some examples, the dehumidification stage 708, including wicking media 709, takes up between 50% and 100% of the surface area 713 of the first side 703 of the plate assembly 700. For instance, the dehumidification stage 708, including wicking media 709, can take up 75% of the surface area 713 of the first side 703 of the plate assembly 700.

Further, the conditioning channel airflow 701 may be cooled as it proceeds through the indirect evaporative cooling stage 710. As illustrated, the indirect evaporative cooling stage 710 includes a plurality of heat transfer elements 714. Each of the heat transfer element 714 includes a pair of fins. The pair of fins may be portions of first plate 702 that fold into the conditioning channel 706. For example, heat transfer element 711A, located within the dehumidification stage 708, includes a first fin 712A and a second fin 712B, and heat transfer element 714A, located within the indirect evaporative cooling stage 710, includes a first fin 715A and a second fin 715B. Each of the fins are configured to engage a side of another plate that defines the conditioning channel 706. As described herein, the plurality of heat transfer elements 714 may be positioned according to a predetermined pattern. For instance, in this example, the plurality of heat transfer elements 714 take up at least 15% of the dehumidification stage 708 surface area of the first side 703 of the first plate 702. In some examples, the plurality of heat transfer elements 714 take up between 5% and 10% of the dehumidification stage 708 surface area of the first side 603 of the first plate 602.

A second side 705 of the first plate 702 along with a first side 733 of the second plate 722 may define an exhaust channel 716. For example, an exhaust channel airflow 717 may proceed through the exhaust channel 716. In some examples, the exhaust channel airflow 717 includes at least a portion 773 of the conditioning channel airflow 701 exiting the conditioning channel 706. The second side 705 of the first plate 702 may include a first wicking media 724 to which a working fluid, such as water, is provided. As the exhaust channel airflow 717 proceeds through the exhaust channel 716, water evaporates from the first wicking media 724 thereby cooling plate assembly 700 and, indirectly, cooling the conditioning channel airflow 701 flowing through the conditioning channel 706.

A second side 734 of the second plate 722 along with a first side 743 of the third plate 742 may define a second conditioning channel 745. As such, plate assembly 700 is configured such that conditioning channels and exhaust channels alternate. For instance, additional plates may be added to plate assembly 700 to configure additional and alternating conditioning channels and exhaust channels.

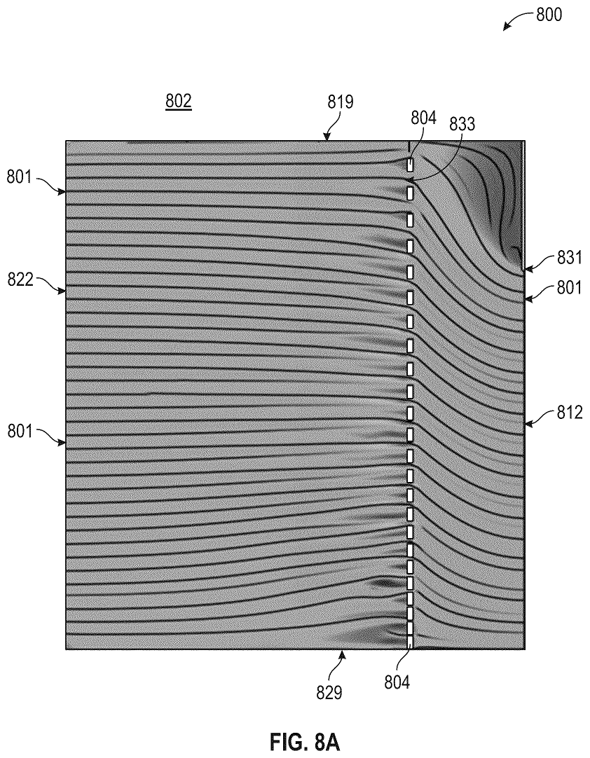

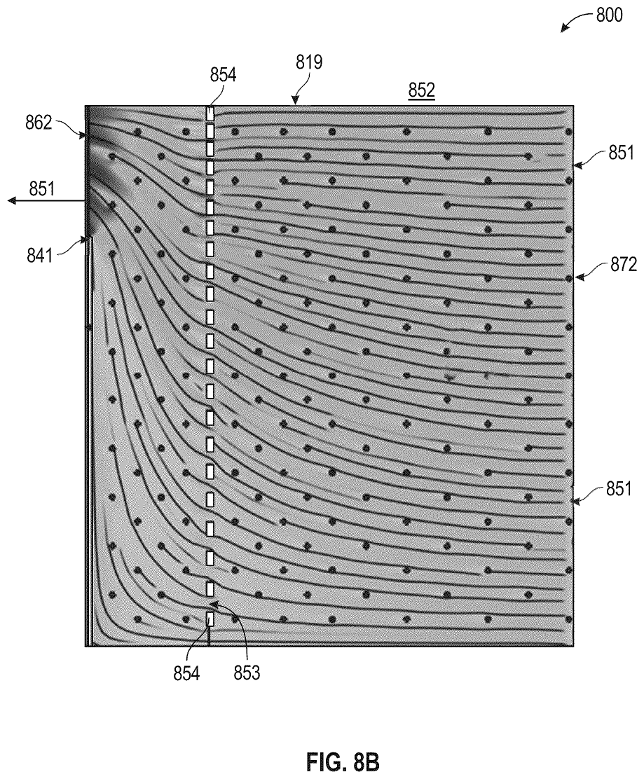

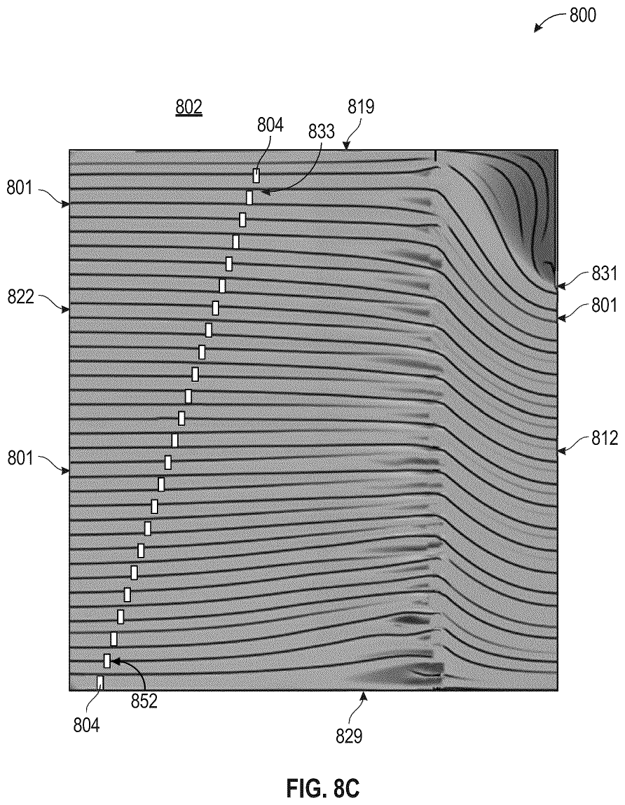

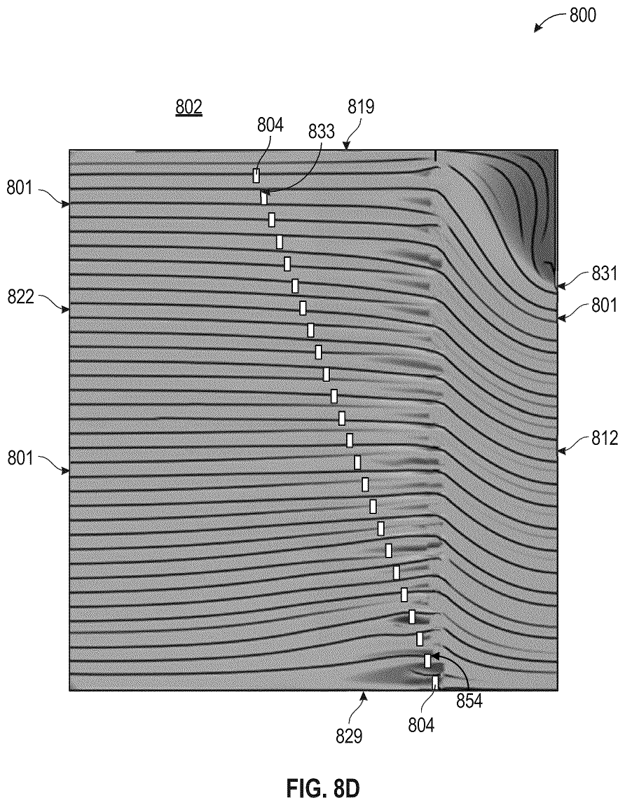

FIG. 8A is a cutaway illustration of an airflow 801 proceeding through a conditioning channel 802 of a plate assembly 800. The plate assembly 800 includes a plurality of support structures 804 that extend between conditioning channel plates of the plate assembly 800. The plurality of support structures 804 are configured to maintain a predetermined width (i.e., between conditioning channel plates) of the conditioning channel 802. Although in this example plate assembly 800 is illustrated with a single row of support structures 804, in other examples, the plurality of support structures 804 may be distributed across one or more portions of the surface of the conditioning channel plates of the plate assembly 800, as described herein. As illustrated, the airflow 801 enters through a first opening 812 of the plate assembly 800 that extends from a second end 829 of the plate assembly to a first opening height 831. The airflow enters the first opening 812 and is diverted by the plurality of support structures 804 as the airflow 801 proceeds through the conditioning channel 802 to be dehumidified and cooled, and exits the conditioning channel 802 of the plate assembly 800 through a second opening 822.

As illustrated in this example, the plurality of support structures 804 are distributed with decreasing spacing between them as positioned from a first end 819 of the plate assembly 800 to the second end 829 of the plate assembly 800. The decreased spacing between the plurality of support structures 804 may allow for more of the airflow 801 to be directed towards the first end 819 of the plate assembly as the airflow 801 enters through the first opening 812 opening of the plate assembly 800, which as noted above extends from the second end 829 of the plate assembly 800 to the first opening height 831 (e.g., rather than to the first end 819) of the plate assembly 800. In some examples, the distance from the second end 829 of the plate assembly 800 to the first opening height 831 is in the range of 50% to 90%, such as 60% to 85%, or 65% to 80% of the distance from the second end 829 to the first end 819 of the plate assembly 800.

In some instances, an average spacing between support structures 804 closer to the first end 819 than the second end 829 of the plate assembly (e.g., support structures 804 within the top half of the plate assembly 800) is greater than an average spacing between support structures closer to the second end 829 of the plate assembly (e.g., support structures 804 within the bottom half of the plate assembly 800). For instance, the spacing between the support structures 804 closer to the first end 819 may allow for a higher percentage of an opening area 833 for airflow 801 to pass-through compared to the opening area 833 allowed by the spacing between the support structures 804 closer to the second end 829. In some instances, the opening areas 833 provided by the spacing between the support structures 804 closer to the first end 819 may be between 50% and 90%, such as 60% to 80%, of the overall opening area provided by the spacing between all of the support structures 804.

In some instances, to provide the opening areas 833 that allow pass-through of the airflow 801, a length of the support structures 804 may vary. For instance, the plurality of support structures 804 may be positioned such that a distance between midpoints of adjacent support structures 804 remains the same, where a length of the support structures 804 may decrease based on their distance from the second end 829 of the plate assembly 800 (e.g., a support structure 804 further from the second end 829 may have a length less than a support structure 804 closer to the second end 829 of the plate assembly 800). Due to the varying lengths, the support structures 804 closer to the first end 819 may provide an overall greater opening for airflow 801 pass-through than the support structures closer to the second end 829 of the plate assembly 800.

In some embodiments, the open area between the support structures 804 of the half of the conditioning channel 802 proximate the first end 819 is greater than the open area between the support structures 804 of the half of the conditioning channel 802 proximate the second end 829. In some embodiments, the open area of the half proximate the first end 819 is at least 5%, or at least 10%, or at least 15%, or at least 20%, or at least 30%, or at least 40%, or at least 50% greater than the open area of the half proximate the second end 829. For example, if the open area of the half proximate the first end 819 is 45% and the open area of the half proximate the second end 829 is 15%, then the open area of the half proximate the first end 819 is 30% greater that the open area of the half proximate the second end 829. The arrangements described herein are adapted to distribute the fluid flow downstream of the support structures 804 evenly across the conditioning channel 802 despite the fact the fluid enters through the first opening 812, which does not extend the entire height of the conditioning channel 802.

Moreover, while FIG. 8A illustrates plate assembly 800 with a single row of support structures 804, in some examples, the support structures 804 may be offset from each other. For example, FIG. 8C illustrates the support structures 804 offset from each other to form a row of support structures at a first angle 852. The first angle 852 may be, for example, between 45 degrees and 90 degrees. In this example, the support structures 804 are distributed such that a support structure 804 that is closer to the first end 819 of the plate assembly 800 than another support structure 804 is closer to the first opening 812 than the other support structure 804. FIG. 8D illustrates the support structures 804 offset from each other to form a row of support structures at a second angle 854. The second angle 854 may be, for example, between 90 degrees and 135 degrees. As illustrated, the support structures 804 are distributed such that a support structure 804 that is closer to the second end 829 of the plate assembly 800 than another support structure 804 is closer to the first opening 812 than the other support structure 804.

FIG. 8B is a cutaway illustration of an airflow 851 proceeding through an exhaust channel 852 of the plate assembly 800. The plate assembly 800 includes a plurality of support structures 854 that extend between exhaust channel plates of the plate assembly 800. The plurality of support structures 854 are configured to maintain a predetermined width (i.e., between exhaust channel plates) of the exhaust channel 852. Although in this example plate assembly 800 is illustrated with a single row of support structures 854, in other examples, the plurality of support structures 854 may be distributed across one or more portions of the surface of the exhaust channel plates of the plate assembly 800, as described herein. As illustrated, the airflow 851 enters through a first opening 872 of the plate assembly 800, is diverted by the plurality of support structures 854 as the airflow 851 proceeds through the exhaust channel 852 extracting heat from the plate assembly 800, and exits the exhaust channel 852 of the plate assembly 800 through a second opening 862 that extends from the first end 819 of the plate assembly to a second opening height 841. In some examples, the plurality of support structures 854 are configured to achieve a desired result to the airflow. For instance, the plurality of support structures 854 may be positioned to achieve a uniform airflow 851, or as close to a uniform airflow 851, as possible.

As illustrated in this example, the plurality of support structures 854 are distributed with increasing spacing between them as positioned from the first end 819 of the plate assembly 800 to the second end 829 of the plate assembly 800. In some examples, the distance from the first end 819 of the plate assembly 800 to the second opening height 841 is in the range of 15% to 50%, 20% to 25%, 10% to 50%, 15% to 40%, or 20% to 35% of the distance from the first end 819 to the second end 829 of the plate assembly 800.

In some instances, an average spacing between support structures 854 closer to the first end 819 than the second end 829 of the plate assembly (e.g., support structures 854 within the top half of the plate assembly 800) is less than an average spacing between support structures closer to the second end 829 of the plate assembly (e.g., support structures 854 within the bottom half of the plate assembly 800). For instance, the spacing between the support structures 854 closer to the first end 819 may allow for a lesser percentage of an opening area 853 for airflow 851 to pass-through compared to the opening area 853 allowed by the spacing between the support structures 854 closer to the second end 829. In some instances, the opening areas 853 provided by the spacing between the support structures 854 closer to the second end 829 may be between 50% and 90%, such as 60% to 80%, of the overall opening area provided by the spacing between all of the support structures 854.

In some instances, to provide the opening areas 853 that allow pass-through of the airflow 851, a length of the support structures 854 may vary. For instance, the plurality of support structures 854 may be positioned such that a distance between midpoints of adjacent support structures 854 remains the same, where a length of the support structures 854 may increase based on their distance from the second end 829 of the plate assembly 800 (e.g., a support structure 854 further from the second end 829 may have a length greater than a support structure 854 closer to the second end 829 of the plate assembly 800). Due to the varying lengths, the support structures 854 closer to the second end 829 may provide an overall greater opening for airflow 851 pass-through than the support structures closer to the first end 819 of the plate assembly 800.

In some embodiments, the open area between the support structures 854 of the half of the exhaust channel 852 proximate the first end 819 is less than the open area between the support structures 854 of the half of the exhaust channel 852 proximate the second end 829. In some embodiments, the open area of the half proximate the second end 829 is at least 5%, or at least 10%, or at least 15%, or at least 20%, or at least 30%, or at least 40%, or at least 50% greater than the open area of the half proximate the first end 819. For example, if the open area of the half proximate the second end 829 is 40% and the open area of the half proximate the first end 819 is 20%, then the open area of the half proximate the second end 829 is 20% greater that the open area of the half proximate the first end 819. The arrangements described herein are adapted to distribute the fluid flow downstream of the support structures 804 evenly across the exhaust channel 852 despite the fact the fluid exits through the second opening 862, which does not extend the entire height of the exhaust channel 852.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

What is claimed is:

1. A plate assembly, comprising:
a first plate comprising:
a first side defining a side of a conditioning channel, the first side configured to receive desiccant; and
a second side, opposite the first side, defining a side of an exhaust channel, at least one of the first side and the second side comprising a plurality of support structures distributed in a predetermined pattern and configured to maintain a predetermined width of the respective conditioning channel or exhaust channel.

2. The plate assembly of claim 1 comprising a second plate, wherein the plurality of support structures are configured to engage the second plate, and wherein the second plate and the second side define the exhaust channel.

3. The plate assembly of claim 1, wherein the plurality of support structures comprise heat transfer elements.

4. The plate assembly of claim 3, wherein the heat transfer elements are fin-shaped.

5. The plate assembly of claim 1, wherein the plurality of support structures comprise embossed features.

6. The plate assembly of claim 5, wherein the embossed features comprise at least one feature that is stamped, molded, machined, 3D printed, or additively attached to the at least one of the first side and the second side of the first plate.

7. The plate assembly of claim 1, wherein the plurality of support structures are uniformly distributed throughout at least a portion of a surface area of the at least one of the first side and the second side of the first plate.

8. The plate assembly of claim 7, wherein the portion of the surface area of the at least one of the first side and the second side of the first plate is less than 15% of the surface area of the at least one of the first side and the second side of the first plate.

9. The plate assembly of claim 7, wherein the portion of the surface area of the at least one of the first side and the second side of the first plate is between 5% and 10% of the surface area of the at least one of the first side and the second side of the first plate.

10. The plate assembly of claim 7, wherein the portion of the surface area of the at least one of the first side and the second side of the first plate is at least 10% of the surface area of the at least one of the first side and the second side of the first plate.

11. The plate assembly of claim 1, wherein a density of a distribution of the plurality of support structures increases from one end of the at least one of the first side and the second side of the first plate to another end of the at least one of the first side and the second side of the first plate.

12. The plate assembly of claim 1, wherein the plurality of support structures are distributed on the first side and are configured to prevent expansion of the conditioning channel.

13. The plate assembly of claim 1 comprising a second plate, wherein the plurality of support structures are configured to engage the second plate, and wherein the second plate and the first side of the first plate define the conditioning channel.

14. The plate assembly of claim 1, wherein the plurality of support structures are distributed on the second side and are configured to prevent collapse of the exhaust channel.

15. The plate assembly of claim 1 comprising a second plate, wherein the plurality of support structures are configured to engage the second plate, and wherein the second plate and the second side of the first plate define the exhaust channel.

16. The plate assembly of claim 1, wherein the plurality of support structures are distributed on each of the first side and the second side of the first plate, wherein at least a first portion of the plurality of support structures distributed on the first side are aligned with at least a second portion of the plurality of support structures distributed on the second side.

17. The plate assembly of claim 1, wherein the plurality of support structures comprise airflow control elements configured to divert airflow within at least one of the exhaust channel and the conditioning channel.

18. The plate assembly of claim 17, wherein the airflow control elements have a uniform distribution with respect to a height of the first side.

19. The plate assembly of claim 17, wherein a density of the airflow control elements is non-uniform along a height of the first side.

20. The plate assembly of claim 17, wherein the airflow control elements are distributed on the first side of the first plate and configured to provide a distribution of airflow across a height of the conditioning channel.

21. The plate assembly of claim 17, wherein the airflow control elements are configured to engage the second plate and divert the airflow across a height of the exhaust channel.

22. The plate assembly of claim 1, wherein the plate assembly comprises a header configured to divert at least a portion of an airflow through the conditioning channel to the exhaust channel.

23. The plate assembly of claim 1, wherein the second side is configured to direct a flow of fluid through the exhaust channel.
